(19) United States
(12) Patent Application Publication
(10) Pub. No.: US 2007/0272307 A1
(43) Pub. Date: Nov. 29, 2007

(54) Sanitary fluid pressure regulator

(76) Inventors: Daryll D. Patterson, Brooklyn Park, MN (US); Todd W. Larsen, Milaca, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(21) Appl. No.: 11/440,535

(22) Filed: May 25, 2006

(51) Int. Cl. G05D 16/10

(52) U.S. Cl. 137/505.13

(57) ABSTRACT

An example pressure regulator includes body having a pressure inlet and a pressure outlet. A piston is disposed in the body and fluidly coupled to the pressure inlet and the pressure outlet. The piston is configured to operate in compression to contact a valve seat for the purpose of controlling the flow of fluid from the pressure inlet to the pressure outlet in response to a pressure applied to a surface of the piston via the pressure control outlet.

### FIELD OF THE DISCLOSURE

The present disclosure relates generally to fluid pressure regulators and, more particularly, to sanitary, pressure reducing regulators for beverage dispensing service.

### BACKGROUND

Many fluid control systems use pressure regulators to control the pressure of a fluid in a pipeline or to control the pressure of a fluid applied to a control device, such as an actuator and valve. Pressure reducing regulators generally receive a relatively high pressure fluid from a fluid supply source and output the fluid at a relatively lower fluid pressure while providing a stable output for a wide range of output loads (i.e., changes in flow requirements or fluid capacity, etc.). One skilled in the art appreciates that pressure regulators generally operate by controlling the position of a restricting element, such as a valve, by applying a balancing force to a measuring element. The balancing force is typically generated by fluid pressure applied to one end of the measuring element to counteract a force generated by a loading element coupled to the measuring element. Conventional pressure regulators may use diaphragms or pistons as a measuring element and a spring as a loading element.

A common problem with many conventional regulator designs is that they are susceptible to inlet supply pressure variations. That is, the stability of the outlet pressure may be highly dependent upon the stability of the inlet supply pressure, which in turn can affect the quality and nature of the fluid being controlled. For example, a pressure reducing regulator having a balanced design to reduce inlet supply pressure sensitivity is described in U.S. Patent Publication No. 2004/0007269. The pressure reducing regulator described in this published patent application is an in-line pressure reducing regulator that uses a single piston as a measuring element in combination with multiple springs operating as a loading element to counteract a control pressure acting on the a measuring element that controls the output pressure. Unfortunately, multiple springs can be problematic in certain applications. For example, in the food and beverage industry, beverage dispensing applications, such as tea dispensers, must also have sanitary flow path to avoid stagnation, and possible contamination, of the beverage. Conventional regulators, such as the one previously described, often place loading elements in the fluid flow path making sanitary operation difficult. Therefore, it would be beneficial to provide a pressure reducing regulator that has a significantly lower manufacturing cost while advantageously providing improved pressure regulation and sanitary operation.

### BRIEF DESCRIPTION OF THE DRAWINGS

FIG. 1 is a cross-sectional view of an example pressure reducing regulator in an open position.

FIG. 2 is a cross-sectional view of an example pressure reducing regulator in a closed position.

### SUMMARY

In one disclosed example, a pressure regulator includes a body having a pressure inlet and a pressure outlet interconnected through a bore within the body. A piston is disposed in the body, fluidly interconnecting the pressure inlet and the pressure outlet forming a passageway and pressure chamber within the bore. The piston is configured to contact a valve seat within the body to control the flow of fluid from the pressure inlet to the pressure outlet in response to a pressure applied to a surface of the piston via the pressure outlet to counteract a loading force supplied by a single spring coupled to the piston.

In another disclosed example, a pressure regulator includes a modular pressure regulator valve assembly fluidly coupled to a pressure inlet and a pressure outlet. The modular pressure regulator valve assembly includes a piston having minimal inlet areas to reduce supply sensitivity and configured to engage a valve seat and to respond to a control pressure to control the flow of fluid between the pressure inlet and the pressure outlet via the valve seat with only the piston and valve seat exposed to the fluid flow.

### DETAILED DESCRIPTION

In general, the example pressure reducing regulator described herein provides a single or unitary regulator body that contains an interior pressure regulating valve to control fluid flow through the regulator. The example pressure regulating valve is a normally-open valve (i.e., at pressures below a predetermined pressure or set point, fluid flows generally unobstructed from the inlet to the outlet) using a single piston and spring to regulate the fluid pressure, and therefore, the fluid flow. The pressure regulating valve accomplishes this by using an output pressure derived from a single pressure source inlet of the regulator body. That is, the output pressure results from a pressure drop across the interior pressure regulating valve that drives the pressure regulating valve, from the outlet or the pressure output side to control valve position. In the preferred embodiment, the pressure regulating valve is based upon a single or unitary piston. The single piston substantially reduces the number of components needed to implement the pressure regulating valve assembly, thereby enabling a more compact design with improved reliability and sanitary operation, while lowering manufacturing and assembly costs. It will also be apparent to one skilled in the art that the design of the pressure reducing regulator, described in greater detail below allows the regulator to be easily used in sanitary operations.

In general, this simple modular design operates using a force balance, in compression, across the piston to maintain the outlet at a predetermined pressure. In the preferred embodiment, the example pressure regulator is configured to provide an increased measuring element area (i.e., an increase in regulator gain or responsiveness to the control pressure) when the outlet pressure falls below a desired, predetermined pressure. The preferred design further includes minimal inlet areas to effectively decouple the output pressure stability from inlet pressure variations. The design also advantageously provides a pressure-assisted shutoff if a fluid leak occurs across the valve seat when the restricting element or valve is closed as explained in greater detail below.

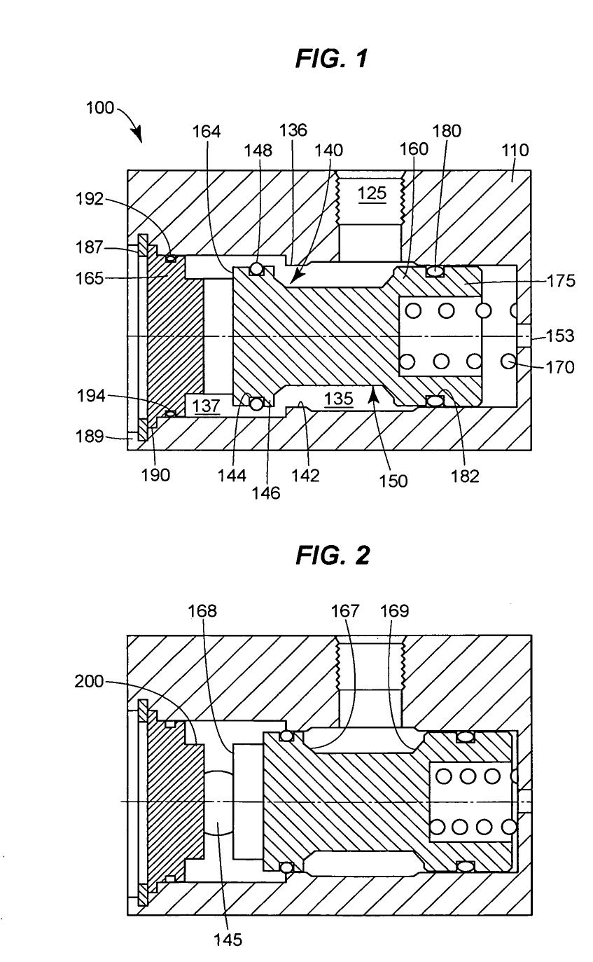

Referring now to FIG. 1, a cross-sectional view of an example pressure reducing regulator [100] is shown for an application to regulate the output pressure of a tea dispenser such as the Model 3 tea dispenser from IMI Cornelius of Mason City, Iowa. The example regulator has a relatively smaller overall size (e.g., approximately 2.25″×1.50″×1.80″) in comparison to known output regulators and has a substantially reduced total number of parts which results in a more reliable and less expensive pressure regulator. As shown, the example regulator [100] is in an open or first position, such as when the regulator is first operated or when output pressure is below a predetermined pressure or set point. In contrast, FIG. 2 is a cross-sectional view of the example pressure reducing regulator [100] in a substantially closed or second position, such as when the output pressure is approximately equal to the set point. As depicted in these figures, the example pressure reducing regulator [100] includes a pressure reducing valve assembly or module [150] disposed within a bore [140] of a single, substantially unitary regulator body or module [110]. The body [110] includes a single pressure inlet [125], which provides a pressure source to the regulator [100]. The pressure reducing valve assembly [150] is positioned within the bore [140] between the inlet [125] and an outlet [145].

The example regulator [100] further includes a bonnet cap [165], as shown, configured to fit a opening of the body created by a widened portion [190] of the bore to seal the regulator body, thereby forming the pressure chamber [137] between the bonnet cap [165] and the valve assembly [140] on the outlet or output side of the bore [140]. An annular seal [192] is placed within a groove [194] in the bonnet cap [165] to form a pressure-tight seal within the body [110]. The bonnet cap [165] is retained within the body [110] using a bonnet cap retainer [187], such as a common C-ring, that engages an upper annular groove [189]. Alternatively, the bonnet cap may threadably attach to the regulator body to form the pressure chamber [137]. The bonnet cap [165] may also include an integral travel stop [200] (shown in FIG. 2) to engage the pressure reducing valve assembly [150] when the regulator is fully opened in a first position (e.g., when there is no inlet pressure or when the outlet pressure in substantially less than the inlet pressure).

As shown, the pressure reducing valve assembly [150] can selectively engage a reduced diameter intermediate portion [136] between the passageway [135] and the pressure chamber [137], which forms a valve seat [142] in the body [110]. The pressure reducing valve assembly [150] of the example pressure regulator is comprised of a single piston [160] (i.e. the measuring element), a loading element [170], and at least one annular seal [180]. More specifically, the piston [160] is a generally cylindrical component that slidably engages the bore [140] of the regulator body to selectably interconnect the pressure inlet [125] and the pressure outlet [145] via the passageway [135], the intermediate portion [136] and the pressure chamber [137] of the bore [140]. The piston [160] has a first sensing surface [164] that receives a control pressure (i.e., the pressure in the chamber [137]) via the pressure outlet [145] in the first position (shown in FIG. 1) when the pressure valve assembly [150] is fully open. The piston [160] further includes a second sensing surface [168] that receives the control pressure via the pressure outlet [145] in a second position (shown in FIG. 2) when the pressure valve assembly [150] is not fully open such as when the pressure valve assembly [150] is substantially closed.

To control fluid flow, the piston [160] has an enlarged portion [146] shaped to contact the valve seat [142] when the pressure reducing regulator is substantially closed position. The piston [160] may also include a receiving portion [175] preferably configured to receive a loading element or spring [170] to provide a predetermined force to counteract and/or balance an outlet pressure force exerted upon either the first and/or second sensing surfaces [164] and [168]. One of ordinary skill in the art should appreciate that the example piston [160], as shown, has axially opposed first and second inlet surfaces [167] and [169] between the enlarged portion [146] and receiving portion [175] of the piston [160] to substantially offset inlet forces of the piston [160] (i.e., the net force across the surfaces are substantially zero) when inlet fluid pressures are exerted upon them. This allows the forces exerted upon the first and second surfaces [164] and [168], in combination with the loading element force, to dominate output pressure control.

In applications requiring sanitary operation, the piston [160] may also include a first annular channel [182] adjacent to the receiving portion of the piston [160] to incorporate an annular seal [180] (e.g., an o-ring) to form a sealed cavity for isolating the loading element [170] and receiving portion [175] of the piston from the fluid flow. This avoids stagnation of fluid (e.g., beverages such as tea) within the regulator [100]. Alternatively, an annular channel could be placed in the bore to accommodate the o-ring seal (not shown). To eliminate any “air spring” effect of the sealed cavity, the body [110] may also include a vent [153] to permit pressure equalization in the area under the receiving portion [175] of the piston. A second annular channel may also be formed within the enlarged portion [146] of the piston [160] to incorporate an additional o-ring to provide for a resilient seal [148] to engage the valve seat [142]. Such a seal could substantially aid in inhibiting or shutting off of the fluid flow from the inlet [125] to the outlet [145] depending upon the application.

In an alternate example, it should be appreciated that the valve seat may be formed from a resilient material, softer than the body material or the piston material, by placing an annular channel or groove within the body to receive the resilient material thereby forming a soft seat. A corresponding annular portion of the piston may be slightly enlarged from the diameter of the first surface [164] of the piston [160] to engage the resilient material to facilitate shutoff (e.g., placing the soft seal in the body as opposed to the piston).

During operation of the example regulator, one of ordinary skill in the art would appreciate that when the piston [160] is in the first position (shown in FIG. 1) the second sensing surface [168] is in contact with the integral travel stop [200], which reduces the overall sensing area of the piston [160] (i.e., when the valve assembly [150] is fully-opened). As a result, when piston [160] is in the first position, the output pressure is substantially less than the set point pressure and the loading force dominates the force balance across the piston. Alternately, when piston [160] is in the second position (as shown in FIG. 2), the output pressure acts upon the combination of first and second sensing surfaces [164] and [168] to increase the fluid pressure forces that counteract the loading force.

From the above description, it should be evident that the pressure valve assembly [150] has two response characteristics or gains during operation. A first response characteristic or gain when the pressure valve assembly [150] is fully open is related to the annular area of the first sensing surface [164]. A second response characteristic or gain occurs when the pressure valve assembly is not in contact with the travel stop [200] and is related to the area of the first and second sensing surfaces [164] and [168]. These two response characteristics or gains allow the example regulator to respond to the countervailing loading forces in a manner such that the regulator has increased or enhanced responsivity to deviations in output pressure when near the set point or desired output pressure (e.g., the pressure regulating valve assembly [150] is in the second position).

In operation before the pressure is controlled, the loading element [170] biases the piston [160] away from the valve seat [142] and into intimate contact with the integral travel stop [200] to permit substantially unrestricted fluid flow from the pressure inlet [125] to the pressure outlet [145]. The fluid flows from the inlet [125] through the passageway [135] and momentarily pressurizes the passageway [135] and pressure chamber [137] to a pressure nearly equal to the inlet pressure. As the outlet pressure increases in the pressure chamber [137], a increasing force is exerted upon the first sensing surface [164] of the piston in a predetermined manner such that a force, related to the annular area of the first sensing surface [164], counteracts the loading force of the loading element [170] and the piston [160] will begin to move, in compression, against the loading element [170] and towards the valve seat [142]. Prior to piston movement in the first position, the control pressure only acts upon the first sensing surface [164] of the piston [160] to generate a force related to the first gain of the regulator. Once the pressure in the pressure chamber [137] is sufficient to generate a force to overcome the initial loading force, the piston [160] moves towards the second position.

In the second position (as shown in FIG. 2), the piston [160] has moved away from the travel stop [200] and the outlet pressure acts upon the first and second sensing surfaces [164] and [168] of the piston [160] to overcome the loading force of the loading element [170]. As previously described, this increased surface area available in the second position provides an increase in gain or responsiveness in the regulator to load demands and may reduce the “droop” (i.e., output deviations from desired pressure) of the regulator. In the second position, the annular surface [146] may continue to move towards the valve seat [142] such that the seal [148] creates a restriction between the pressure inlet [125] and the pressure outlet [145], which subsequently decreases the fluid flow, causing a decrease in pressure at the outlet [145].

It may be appreciated that when the annular surface [146] engages the valve seat [142] (i.e., valve shutoff) the seal [148] substantially closes the pressure valve assembly and essentially prevents flow between the pressure inlet [125] and the pressure outlet [145]. If there is a leak between the seal [148] and the valve seat [142], the output pressure may rise above the set point. In such a condition, the additional fluid flow creates an increase in the pressure of the outlet side of the pressure valve assembly [150] and an additional closure force is generated against the first and second sensing surfaces [164] and [168]. The additional force generated by the leak increases in proportion to the pressure differential across the seat to “positively shut-off” the pressure valve assembly [150] to quickly return the output pressure to the set point.

From the foregoing description, it should be apparent that this modulation of the piston [160] occurs continually during regulator operation to control the fluid flow through the regulator based upon the outlet pressure. The piston [160] continually operates in compression about the valve seat [142] under a force balance during pressure regulation. That is, when the pressures urging the piston away from the seat and toward the seat are in balance, the pressure at the outlet [145] is substantially equal to the predetermined set point as substantially determined by the sensing surfaces [164] and [168] and the spring rate of the spring or loading element [170].

Thus, it should be appreciated that the multiple response characteristics or gain of the regulator improves the overall sensitivity of the outlet pressure regulation to load changes and the reduced and offsetting inlet areas substantially eliminates susceptibility of outlet pressure deviations to inlet pressure variations. Further, it should also be appreciated that the regulator body, piston, and bonnet cap may be made of metal such as, for example, brass, stainless steel, or any other metal or material suitable for the intended application of the pressure reducing regulator, including engineered plastics such as Delrin®, from DuPont E I De Nemours & Co. of Wilmington, Del.

Although certain apparatus, methods, and articles of manufacture have been described herein, the scope of coverage of this patent is not limited thereto. To the contrary, this patent covers all embodiments fairly falling within the scope of the appended claims either literally or under the doctrine of equivalents.

What is claimed is:

1. A pressure regulator [100] comprising:
a body [110] having a pressure inlet [125], a pressure outlet [145], a bore [140] interconnecting the pressure inlet [125] with the pressure outlet [145], and a valve seat [142] located within the bore [140];
a piston [160] disposed in the bore [140] for selectively engaging the valve seat [142] in the bore [140] for controlling a fluid flowing from the pressure inlet [125] to the pressure outlet [145], and
a loading element [170] operatively coupled to the piston [160], wherein the loading element [170] exerts a loading force upon on the piston [160] causing the loading element [170] to produce a predetermined balance force to counteract an outlet force produced by an outlet pressure produced by the fluid flow through the pressure regulator.

2. A pressure regulator [100] as defined in claim 1, wherein the piston [160] is a substantially single member.

3. A pressure regulator [100] as defined in claim 1, wherein the piston [160] at least a first inlet surface [167] and a second inlet surface [169] configured to substantially reduce an inlet fluid force that opposes the outlet force.

4. A pressure regulator [100] as defined in claim 1, wherein the loading element [170] is a spring.

5. A pressure regulator [100] as defined in claim 4, wherein the piston [160] further comprises a first seal to isolate the loading element [170] from the fluid flow.

6. A pressure regulator [100] as defined in claim 1, wherein the piston [160] further comprises a sealing ring [54] to contact the valve seat [142].

7. A pressure regulator [100] as defined in claim 1, wherein the forces on the piston [160] are in opposition such that the piston [160] is operated in compression across the valve seat [142].

8. A pressure regulator [100] as defined in claim 1, wherein the piston [160] defines a first sensing surface [164] such that the fluid force exerted upon the first sensing surface [164] counteracts the force exerted by the loading element [170] when the piston [160] is in a first position.

9. A pressure regulator [100] as defined in claim 8, wherein the piston [160] defines a second sensing surface [168] such that the fluid force exerted upon on the first and second sensing surfaces [164] and [168] counteract the loading force exerted by the loading element [170] when the piston is in a second position.

10. A pressure regulator [100] as defined in claim 1, wherein the piston [160] engages the valve seat [142] to substantially close the bore [140] between the pressure inlet [125] and the pressure outlet [145] such that fluid leaking across the valve seat [142] creates an additional outlet force on the piston [160].

11. A modular pressure regulator [100] comprising:
a body module [110] having a pressure inlet [125], a pressure outlet [145], and a bore [140] therethrough; and
a pressure regulating valve module [150] disposed in the bore [140] and fluidly coupled to the pressure inlet [125] and pressure outlet [145], wherein the pressure regulating valve module [150] is configured to operate across a valve seat [142] disposed within the bore [140] to control fluid flow from the pressure inlet [125] to the pressure outlet [145], wherein the pressure regulating valve module [150] further comprises:
a measuring element [160], wherein the measuring element [160] is configured to respond to the fluid force generated by an outlet pressure, and
a loading element [170], wherein the loading element [170] is operatively coupled to the measuring element [160] and is configured to generate a counteracting force in opposition to the fluid force exerted upon the measuring element [160].

12. A modular pressure regulator [100] as defined in claim 11, wherein the pressure regulating valve module [150] includes at least a first inlet surface [167] and a second inlet surface [169] configured to substantially reduce an inlet fluid force that opposes the fluid force generated by the outlet pressure.

13. A modular pressure regulator [100] as defined in claim 11, wherein the pressure regulating valve module [150] further comprises a first seal to isolate the loading element [170] from the fluid flow.

14. A modular pressure regulator [100] as defined in claim 11, wherein the pressure regulating valve module [150] further comprises a sealing ring [54] to sealingly engage the valve seat [142].

15. A modular pressure regulator [100] as defined in claim 11, wherein the forces on the pressure regulating valve module [150] are in opposition such that the pressure regulator valve module [150] is operated in compression across the valve seat [142].

16. A modular pressure regulator [100] as defined in claim 11, wherein the pressure regulator [100] further includes a first regulator gain when the pressure regulating valve module [150] is in a first position and a second regulator gain when the pressure regulating valve module [150] is in a second position.

17. A modular pressure regulator [100] as defined in claim 16, wherein the first regulator gain is defined by a first sensing surface [164] when the pressure regulating valve module [150] is in a first position.

18. A modular pressure regulator [100] as defined in claim 16, wherein the second regulator gain is defined by at least a second sensing surface [168] when the pressure regulating valve module [150] is in a second position.

19. A modular pressure regulator [100] as defined in claim 11, wherein the pressure regulating valve module [150] engages the valve seat [142] to substantially close the bore [140] between the pressure inlet [125] and the pressure outlet [145] such that fluid leaking across the valve seat [142] creates an additional outlet force on the pressure regulating valve module [150].
